(19) United States
(12) Patent Application Publication
(10) Pub. No.: US 2023/0415350 A1
(43) Pub. Date: Dec. 28, 2023

(54) INFORMATION PROCESSING DEVICE, INFORMATION PROCESSING METHOD, INFORMATION PROCESSING SYSTEM, ROBOT SYSTEM, AND PROGRAM

(71) Applicants: MITSUBISHI CHEMICAL CORPORATION, Tokyo (JP); KEIO UNIVERSITY, Tokyo (JP)

(72) Inventors: Qi GAO, Tokyo (JP); Ken PRADEL, Tokyo (JP); Naoki YAMAMOTO, Yokohama-shi (JP); Yudai SUZUKI, Yokohama-shi (JP)

(73) Assignees: MITSUBISHI CHEMICAL CORPORATION, Tokyo (JP); KEIO UNIVERSITY, Tokyo (JP)

(21) Appl. No.: 18/463,674

(22) Filed: Sep. 8, 2023

Related U.S. Application Data
(63) Continuation of application No. PCT/JP2022/010684, filed on Mar. 10, 2022.

(30) Foreign Application Priority Data
Mar. 10, 2021 (JP) 2021-038525
Feb. 4, 2022 (JP) 2022-016692

(51) Int. Cl. B25J 9/16; G06N 10/20

(52) U.S. Cl. CPC B25J 9/1697; G06N 10/20

(57) ABSTRACT

An information processing device (10) includes: a first acquisition section (12) that acquires input data; a generation section that generates, from the input data, reservoir input data which is to be input to a quantum reservoir (20) having a plurality of layers of sub-reservoirs; a second acquisition section (12) that acquires an output result of the quantum reservoir to which the reservoir input data has been input; and an output data generation section (14) that generates output data with reference to the output result.

### TECHNICAL FIELD

The present invention relates to an information processing device, an information processing method, an information processing system, a robot system, and a program.

### BACKGROUND ART

In recent years, artificial intelligence has been utilized in various fields, and development of new artificial intelligence technology is also in progress. As a kind of next generation artificial intelligence, a technique of machine learning called reservoir computing is attracting attention. Moreover, research on robot motion control and various types of information processing using reservoir computing are also attracting attention.

Driven from recurrent neural network theory, reservoir computing is a method for processing information generated by non-linear dynamic system. The reservoir computing is constituted of an input layer, a reservoir layer, and an output layer. After time series data is injected into the input layer, the reservoir layer nonlinearly transforms the data to extract the features of inputs, followed by the output layer producing the target values. Note only the readout part is trained by a simple training technique such as linear regression. Therefore, training can be carried out efficiently. In view of this, the reservoir computing is expected to be applied to cases where processing and analysis of data are performed in real time.

The reservoir layer, which plays an important role in reservoir calculation, generates a useful time-space pattern from input data. Therefore, techniques in which the reservoir layer is substituted by physical systems have been suggested. It is possible to create high-dimensional time and space with use of complicated physical system that has nonlinearity and high degree of freedom and easily carry out learning of data through the high-dimensional time and space. The advantages of such reservoirs are less power consumption and faster processing. Therefore, such a reservoir is suitable for control of a robot and the like and various kinds of information processing.

However, it is difficult to design a physical system to be utilized as a reservoir layer so as to achieve high learning accuracy. The reason is as follows: so far, although reservoir calculation methods have been proposed in each of which soft robotics, tensegrity, or the like are used as a reservoir, it is not clear how and what kind of physical system should be designed to achieve high accuracy (e.g., see Non-patent Literatures 1 and 2).

In order to solve such problems, various physical systems have been utilized as reservoirs. Among those, recently, a technique has been proposed which utilizes quantum system such as quantum computer with a motivation that the dynamics of the system is complex enough to possess a high degree of freedom. In this technique, quantum dynamics reproduced by a quantum computer having n qubits can utilize a 2\hat{ }n-dimensional quantum space for feature extraction of time series data. Therefore, it can be expected that high-precision learning can be performed by utilizing such a technique successfully.

Designing of a reservoir layer realized by a quantum computer is still in the research stage. However, in recent years, it has been proposed to design a reservoir layer using a quantum state of qubit (e.g., see Non-patent Literatures 3 and 4).

### CITATION LIST

### Non-patent Literature

[Non-patent Literature 1]

Caluwaerts, K., Despraz, J. Iscen, A., Sabelhaus, A. P., Bruce, J., Schrauwen, B., & SunSpiral, V. (2014). Design and control of compliant tensegrity robots through simulation and hardware validation. J. R. Soc. Interface 11, 98.

[Non-patent Literature 2]

Nakajima, K., Hauser, H., Li, T., & Pferfer, R. (2015). Information Processing via physical soft body. Sci. Rep. 5, 10487.

[Non-patent Literature 3]

Fujii, K., & Nakajima, K. (2017). Harnessing disordered-ensemble quantum dynamics for machine learning. Physical Review Applied, 8 (2), 024030.

[Non-patent Literature 4]

Chen, J., Nurdin, H. I., & Yamamoto, N. (2020). Temporal information processing on noisy quantum computers. arXiv preprint arXiv: 2001.09498.

### SUMMARY OF INVENTION

### Technical Problem

In the method disclosed in Non-patent Literature 3, learning accuracy is greatly affected by performance of a quantum computer. Existing quantum computers, however, are medium-scale, error-prone devices. Therefore, a reservoir using an existing quantum computer has problems that such a reservoir provides an output different from that of an ideal quantum computer (i.e., a large-scale qubit system quantum computer with no error) and cannot learn with high accuracy. Such quantum computers are called noisy intermediate-scale quantum (NISQ) devices, and the age of NISQ devices is predicted to continue at least until around 2030 to 2040. In order to achieve practical applications of robot control and various kinds of information processing by reservoirs using quantum computers, development of a quantum reservoir which functions on an NISQ device is demanded.

An object of the present invention is to provide a technique which makes it possible to suitably carry out various kinds of information processing including control of a robot with use of a quantum reservoir generated from NISQ device.

### Solution to Problem

The inventors of the present invention have found, as a result of diligent studies, the noise can also be utilized to enhance the complexity of quantum dynamics, and the above described object is achieved by intentionally utilizing the qubit noise in design of a reservoir. The present invention is based on such findings.

An information processing device in accordance with an aspect of the present invention includes: a first acquisition section that acquires input data; a generation section that generates, from the input data, reservoir input data (i.e. reservoir state) which is to be input to a quantum reservoir having a plurality of layers of sub-reservoirs; a second acquisition section that acquires an output result of the quantum reservoir to which the reservoir input state has been injected; and an output data generation section that generates output data with reference to the output result.

An information processing device in accordance with an aspect of the present invention includes: a first acquisition section that acquires training data including input data and label data; a generation section that generates, from the input data, reservoir input data which is to be input to a quantum reservoir having a plurality of layers of sub-reservoirs; a second acquisition section that acquires an output result of the quantum reservoir to which the reservoir input state has been injected; and a training section that trains, with use of the label data, an output data generation section which generates output data with reference to the output result.

An information processing device in accordance with an aspect of the present invention includes: a quantum reservoir having a plurality of layers of sub-reservoirs; a first acquisition section that acquires reservoir input data which has been generated from time series data; a second acquisition section that acquires an output result of the quantum reservoir to which the reservoir input data has been input; and an output section that outputs the output result.

An information processing system in accordance with an aspect of the present invention includes a first information processing device and a second information processing device, the first information processing device including a first acquisition section that acquires input data, a generation section that generates, from the input data, reservoir input data which is to be input to a quantum reservoir having a plurality of layers of sub-reservoirs, a second acquisition section that acquires an output result of the quantum reservoir to which the reservoir input data has been input, and an output data generation section that generates output data with reference to the output result, and the second information processing device including a quantum reservoir having a plurality of layers of sub-reservoirs, a third acquisition section that acquires reservoir input data which has been generated by the generation section of the first information processing device, a fourth acquisition section that acquires an output result of the quantum reservoir to which the reservoir input data has been input, and an output section that outputs the output result.

An information processing method in accordance with an aspect of the present invention includes: a first acquisition step of acquiring input data; a generation step of generating, from the input data, reservoir input data which is to be input to a quantum reservoir having a plurality of layers of sub-reservoirs; a second acquisition step of acquiring an output result of the quantum reservoir to which the reservoir input data has been input; and an output data generation step of generating output data with reference to the output result.

An information processing method in accordance with an aspect of the present invention includes: a first acquisition step of acquiring training data including input data and label data; a generation step of generating, from the input data, reservoir input data which is to be input to a quantum reservoir having a plurality of layers of sub-reservoirs; a second acquisition step of acquiring an output result of the quantum reservoir to which the reservoir input data has been input; and a training step of training, with use of the label data, an output data generation section which generates output data with reference to the output result.

An information processing method in accordance with an aspect of the present invention includes: a first acquisition step of acquiring reservoir input data which has been generated from time series data; a second acquisition step of acquiring an output result of a quantum reservoir to which the reservoir input data has been input, the quantum reservoir having a plurality of layers of sub-reservoirs; and an output step of outputting the output result.

A program in accordance with an aspect of the present invention is a program for causing a computer to function as an information processing device, the program causing the computer to carry out: a first acquisition step of acquiring input data; a generation step of generating, from the input data, reservoir input data which is to be input to a quantum reservoir having a plurality of layers of sub-reservoirs; a second acquisition step of acquiring an output result of the quantum reservoir to which the reservoir input data has been input; and an output data generation step of generating output data with reference to the output result.

A program in accordance with an aspect of the present invention is a program for causing a computer to function as an information processing device, the program causing the computer to carry out: a first acquisition step of acquiring training data including input data and label data; a generation step of generating, from the input data, reservoir input data which is to be input to a quantum reservoir having a plurality of layers of sub-reservoirs; a second acquisition step of acquiring an output result of the quantum reservoir to which the reservoir input data has been input; and a training step of training, with use of the label data, an output data generation section which generates output data with reference to the output result.

### Advantageous Effects of Invention

According to the present invention, it is possible to suitably carry out information processing that utilizes the advantages of a quantum reservoir using a quantum computer (NISQ device) having less qubits.

### BRIEF DESCRIPTION OF DRAWINGS

FIG. 1 is a schematic diagram illustrating a robot system in accordance with an embodiment of the present invention.

FIG. 2 is a conceptual diagram illustrating a reservoir layer.

FIG. 3 is a diagram illustrating a construction example of a reservoir layer.

FIG. 4 is a schematic diagram illustrating a quantum circuit.

FIG. 5 is a conceptual diagram illustrating a reservoir layer using a quantum computer.

FIG. 6 is a schematic diagram illustrating an information processing system that uses a quantum computer through a cloud.

### DESCRIPTION OF EMBODIMENTS

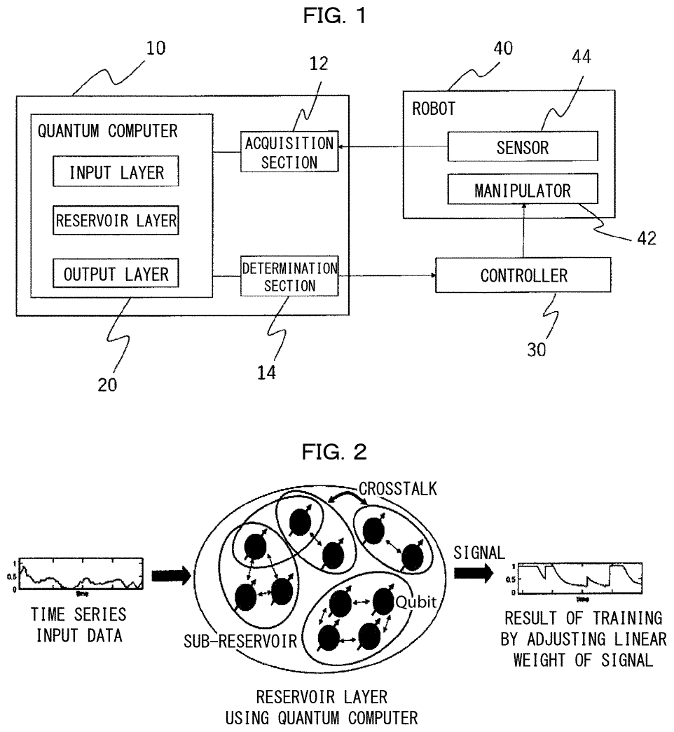

The following description will discuss an embodiment of the present invention with reference to the drawings. As illustrated in FIG. 1, a robot system in accordance with the present embodiment includes a robot 40, and a robot control system that includes a determination device 10 and a controller 30 and that controls the robot 40.

The robot 40 includes a manipulator 42 and a sensor 44. For example, in a case where the robot 40 is a humanoid robot, an arm corresponds to the manipulator 42. The sensor 44 senses an operation of the manipulator 42, and generates time series signals. The sensor 44 in accordance with the present embodiment mainly senses time series motions of the robot 40. The sensor 44 may be incorporated in the manipulator 42 or may be provided at a position different from the manipulator 42.

For example, in a case of a robot hand in which the manipulator 42 grips and lifts an object, the sensor 44 can be a pressure sensor that is provided at a part where the manipulator 42 holds an object. The pressure sensor is preferably not one that distinguishes between two values indicating whether or not an object has made contact, and is preferably one that can continuously detect and output changes in pressure.

When the robot hand grips an object, the pressure sensor outputs continuous pressure changes in response to the gripping force. By transmitting the output values of the pressure sensor to the computer and carrying out training, it is realized that the robot 40 grips a particular object with appropriate force.

To a part other than the holding part of the manipulator 42, a vibration sensor as the sensor 44 may be attached so as to analyze a situation based on vibration and the like at the time of holding an object. The vibration sensor outputs continuous vibration changes when the manipulator 42 carries an object. By transmitting the output values of the vibration sensor to the computer and carrying out training, it is realized that the robot 40 corrects the posture of the arm holding an object and carries the object stably.

A camera sensor as the sensor 44 may be attached to the manipulator 42 so as to analyze a surrounding situation at the time of holding an object. For example, in a case where an operation is performed in which several manipulators carry an object in cooperation with each other in the same place, a camera sensor mounted on one of the manipulators outputs time series image files that identify movements of the surrounding manipulators. By transmitting the output time series image files to a computer and carrying out training, an operation in cooperation with the other manipulators in a good balance is realized.

Other sensors that would be suitably used are ones that can provide continuous or intermittent data over time. Specifically, a sound sensor, a tactile sensor, and/or the like can be used.

The controller 30 controls the manipulator 42 by providing the manipulator 42 with an action command which has been programmed in advance. The controller 30 may be incorporated in the manipulator 42.

The manipulator 42 operates according to a command provided from the controller 30. The sensor 44 outputs time series signals in accordance with an action of the manipulator 42.

The determination device 10 includes an acquisition section 12, a determination section 14, and a quantum computer 20.

The acquisition section 12 acquires time series signals (sensor data) from the sensor 44 via a network. The network is a wired or wireless communication network, and may be the Internet or a LAN.

The quantum computer 20 includes an input layer, a reservoir layer, and an output layer. Time-series signals acquired by the acquisition section 12 are input to the input layer of the quantum computer 20, and training using the signals is carried out according to the schematic view of FIG. 2 (described later).

The determination section 14 determines, from an output of the quantum computer 20, a next action to be made by the manipulator 42, and notifies the controller 30 of the determination result. The controller 30 translates the notified determination result into an action command for the manipulator 42, and controls the manipulator 42. By repeating this cycle, comprehensive action control of the manipulator 42 is achieved.

For example, in a case where the manipulator 42 serving as a robot hand holds an object, and transfers the object to a transference destination corresponding to a type of object, an output of the sensor 44 is input to the quantum computer 20, and the determination section 14 notifies the controller 30 of the determination result of the type of object based on an output of the quantum computer 20. The controller 30 controls the manipulator 42 to transfer the object to a destination corresponding to the notified type. The object can be waste, a food (such as fruit or vegetables), or other objects.

The acquisition section 12 and the determination section 14 can be constituted by a (classical) computer provided with a CPU, a ROM, a RAM, a communication section, and the like.

In order to control complicated actions of the manipulator 42 with high accuracy using the robot control system, it is necessary to design a reservoir layer having high-precision learning ability. The following description will discuss the reservoir layer in accordance with the present embodiment with reference to the conceptual diagram illustrated in FIG. 2.

The quantum computer 20 includes: an input layer to which time series data necessary for learning is input; a reservoir layer that maps the data onto a high-dimensional quantum space; and an output layer that outputs a training result.

It is assumed that the reservoir layer includes n qubits (where n is an integer of 2 or more), and that, in an NISQ device, the reservoir layer is affected by noise interacting through an external environment. In the present embodiment, first, grouping of the qubits in the reservoir layer is carried out in order to utilize complicated quantum dynamics by utilizing the noise. Each group includes two or more qubits. Hereinafter, the group is referred to as a sub-reservoir.

Next, for each of the sub-reservoirs, a specific quantum circuit corresponding to nonlinear transformation of input time series data into higher dimensional space is designed. The quantum circuits in the respective sub-reservoirs can be the same or different.

Next, using the designed quantum circuit, time series data to be learned is input to the sub-reservoir in order of time, and the quantum circuit is executed. Thus, the training data is mapped onto the high-dimensional quantum space through the individual sub-reservoirs.

The sub-reservoirs each are under crosstalk noise from the surrounding sub-reservoirs when executing the quantum circuit. Therefore, time series data is mapped onto the quantum space differently for each of the sub-reservoirs. This improves the degree of freedom and nonlinearity of the reservoir layer, and consequently results in different outputs of the individual sub-reservoirs which are obtained by observing the execution results of the quantum circuits.

Lastly, training of connection weights of the output layer is carried out by linear regression so that an error between an output value and a target value is minimized for each of those output results.

In other words, the acquisition section 12 acquires time series data (training data) to be leaned and a target value (label data associated with the time series data), and the determination device 10 is configured to train the output layer so that an error between an output value which is output from the output layer when the time series data is input to the input layer of the quantum computer 20 and the target value is minimized.

In order to verify the effectiveness of the reservoir layer in accordance with the present embodiment, it is necessary to confirm two conditions using a quantum computer. One condition is that the system of the reservoir has nonlinearity. The other condition is that the system of the reservoir has a property (called fading memory) that the current input has greater influence on the current internal state than inputs or states in the past.

Empirically, in order to realize reservoir computing with higher computational performance, the reservoir needs to have the properties of nonlinearity and fading memory. In order to confirm these two properties, the effectiveness of the reservoir layers in accordance with the present embodiment was verified with a task for standard benchmark test, called nonlinear autoregressive moving average (NARMA) task. Formula (1) shows the NARMA task.

sₗ=0.1(sin(2παl)sin(2πβl)sin(2πγl)+1)

yₗ₊₁=0.4yₗ+0.4yₗyₗ₋₁+0.6sₗ³+0.1 (1)

where sl is an input value when time step=1, and yl is a target value. α, β and γ are set to 2.11, 3.73 and 4.11, respectively. This formula has two characteristics. One characteristic is that a change in time series y is nonlinear. The other characteristic is that the change in y depends on a time lag. Therefore, a reservoir layer needs to store nonlinearity and the time series in the past in order to accurately predict time series data of the NARMA task.

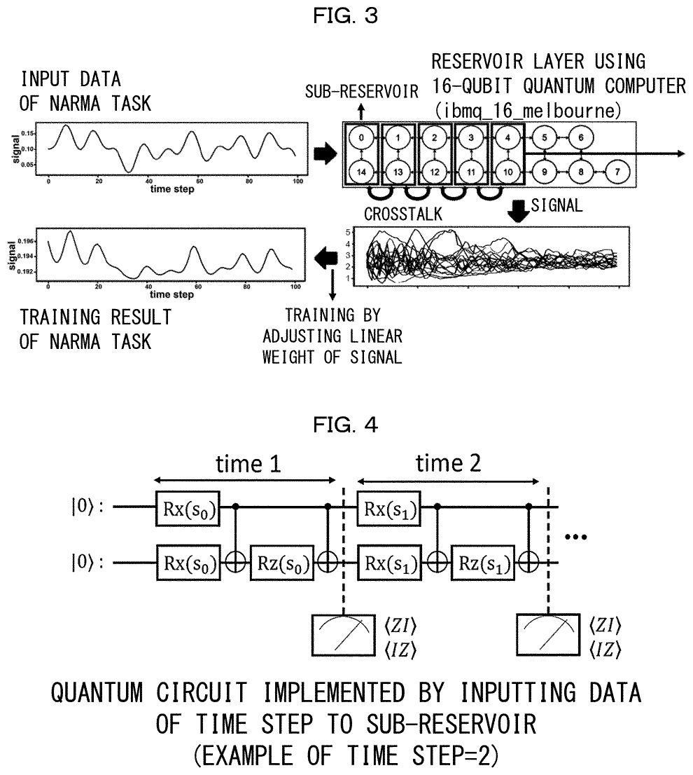

FIG. 3 shows an example in which a quantum reservoir is constructed using a 16-qubit quantum computer (ibmq_16_melbourne) manufactured by IBM, and 100-time step data of the NARMA task of Formula (1) is learned.

As illustrated in FIG. 3, first, one sub-reservoir is created using two adjacent qubits (e.g., 0th and 14th qubits). Similarly, another two adjacent qubits (e.g., 1st and 13th qubits) are used to create one sub-reservoir. This operation is repeated to create sub-reservoirs, and a reservoir layer is ultimately created with a plurality of connected sub-reservoirs. FIG. 3 shows an example of a reservoir layer constructed with five sub-reservoirs.

In data learning in the 100-time step NARMA task, pieces of data of individual time steps in time series to be learned are input to each of the sub-reservoirs using the quantum circuit illustrated in FIG. 4, and calculation by the quantum circuit is carried out to obtain output.

FIG. 4 shows an example of a quantum circuit using two qubits with time step=2. Pieces of data with time step=1 and time step=2 are input to the quantum circuit with time step=2 illustrated in FIG. 4. Each input includes five quantum gates.

In this quantum circuit, first, an X rotation operation in which input data serves as a rotation angle is applied to each qubit. Next, a CNOT gate that acts across two qubits is applied, a Z rotation operation that acts on the second qubit is applied, and then the CNOT gate is applied again. Thus, a strong correlation is developed between the two qubits. Note, however, that the rotation angle of the Z rotation operation is also represented by input data.

By repeatedly executing such a quantum circuit for each time step, a quantum state that depends on time series data is generated. As a precaution, although the present embodiment employs such a quantum circuit structure, different quantum gates may be used.

Thus, in the determination device 10, time series data acquired by the acquisition section 12 is divided into pieces of data in a plurality of time steps (time slices), and thus reservoir input data is generated. Data at each time step or a representative value of data included in the generated reservoir input data is input to each sub-reservoir via the input layer. Here, the process of dividing time series data into the plurality of time steps may be carried out by the input layer, or may be carried out by another component in the determination device 10.

As described above, in the determination device 10, one or more quantum computations are carried out with respect to qubits constituting each sub-reservoir. Information designating the quantum computation can be included in data that is input to the input layer or the reservoir layer, for example.

Specific unitary transformation (unitary gate) (such as the X rotation operation, the CNOT gate, and the Z rotation operation with respect to two qubits described above) are limited in view of the degree of freedom of the entire unitary transformation. This means that the quantum circuit (hardware-efficient ansatz) has the reduced number of gates and is executable on NISQ devices. However, due to the influence of noise described above, the complexity of dynamics in the quantum reservoir can be utilized. This means that the quantum circuit (hardware-efficient ansatz) has the reduced number of gates and is executable on NISQ devices. However, due to the influence of noise described above, the complexity of dynamics in the quantum reservoir can be utilized. By thus using restricted unitary transformation, the number of gates used for quantum computation is reduced, and a quantum circuit (hardware-efficient ansatz) that can be executed on the NISQ device is obtained. In other words, the complexity of dynamics in the quantum reservoir is not attributed to the degree of freedom of unitary transformation, but to the influence of noise described above. Therefore, it is possible to exert the function of the quantum reservoir even in a simple quantum circuit such as a restricted unitary transformation.

Even though calculations were carried out with the same quantum circuit for individual sub-reservoirs, different outputs were obtained in the reservoir layer constructed with the other five sub-reservoirs as illustrated in FIG. 3. This is due to the influence of noise interacting with the external environment (such as sub-reservoirs around the qubit) when executing the quantum circuit in the individual sub-reservoirs.

That is, in the process of constructing the reservoir layer in accordance with the present embodiment, it has been shown that quantum noise of qubit can be utilized. In addition, it has also been shown that a high-dimensional quantum space with a high degree of freedom is created due to greatly differing outputs which are obtained from the individual sub-reservoirs.

Table 1 shows normalized mean square error (NMSE) values of prediction results of the NARMA task. As a comparative example, an NMSE value of linear regression is also indicated. The NMSE value is a standard means for evaluating prediction accuracy, and is calculated from Formula (2).

NSME=Σ_{l=L+1}^{M}(y̅ₗ−yₗ)²/Σ_{l=L+1}^{M}yₗ² (2)
yₗ is a target value, y̅ₗ is a prediction value
M is a total number of time steps, L is the number of learning time steps

In the 100-time step NARMA task, the first 10-step data is not used as “wash out” data, the following 70-step data is used as training data, and the last 20-step data is used as prediction data.

TABLE 1

| | | | | | | Comparative |
|---|---|---|---|---|---|---|
| | | | | | | Example |
| | Reservoir layer | | | | | Linear |
| | 2 sub- | 3 sub- | 4 sub- | 5 sub- | 6 sub- | regression |
| | reservoirs | reservoirs | reservoirs | reservoirs | reservoirs | learning |
| NMSE | 1.71 × 10⁻⁵ | 1.55 × 10⁻⁵ | 1.3 × 10⁻⁵ | 1.3 × 10⁻⁵ | 8.9 × 10⁻⁶ | 8.0 × 10⁻⁴ |
| average | | | | | | |
| value | | | | | | |
| NMSE | 8.64 × 10⁻⁶ | 8.0 × 10⁻⁶ | 6.3 × 10⁻⁶ | 2.7 × 10⁻⁶ | 2.7 × 10⁻⁶ | |
| standard | | | | | | |
| deviation | | | | | | |

As shown in Table 1, it has been confirmed that, as the number of sub-reservoirs in the reservoir layer increases, both the average value and the standard deviation of NMSE become smaller, and the prediction accuracy is improved. From this result, it has been confirmed that the prediction accuracy is improved by several tens of percent as compared to conventional linear regression learning, provided that two or more sub-reservoirs are used. In a quantum reservoir using six sub-reservoirs, prediction accuracy several times higher than an NSME value of linear regression is obtained, and thus superiority of calculation accuracy of the quantum reservoir in accordance with the present embodiment is indicated.

Robot action control performance of the robot control system in accordance with the present embodiment was verified. An experiment was carried out to check whether a reservoir can predict an action of a robot hand of a robot, which is a manipulator having the robot arm and a robot hand with two fingers.

A vacuum-driven soft gripper manufactured by piab company was used as the robot hand with two fingers. A four-axis robot arm (Dobot Magician, a linkage that can be used on a desktop) was used as the robot arm. The action of the robot hand was controlled using software Dobot Studio.

A film sensor was attached to the robot hand with two fingers. The film sensor had a negatively charged dome-shaped silicon layer and a positively charged nylon layer, and the silicon layer and the nylon layer were provided with copper and aluminum electrode layers.

When the robot hand carries out actions such as gripping and releasing an object, pressure is applied to the dome-shaped silicon layer, and negative and positive frictional charges are generated in the electrodes, and thus a voltage is generated.

Three kinds of objects (object A, object B, and object C) having different shapes were prepared, which were made of plastic, had almost the same weight (approximately 16 g), and had almost the same volume (approximately 27 cm³). The shapes of the objects A and B were cubes, and the shape of the object C was a sphere. The material of the object A was ABS synthetic plastic, and the material of the objects B and C was PLA synthetic plastic.

For each of the objects, the following experiment was carried out. In the experiment, an action in which the robot hand with two fingers provided with the film sensor gripped and released was repeated 25 times. In accordance with the action of the fingers of the robot hand, a change in voltage over time occurred in the film sensor, and data of time series voltage changes was obtained. For each of the objects, voltage data for the two fingers was obtained. It was verified whether a reservoir calculation using a quantum computer can distinguish between the objects by learning the data of time series voltage changes.

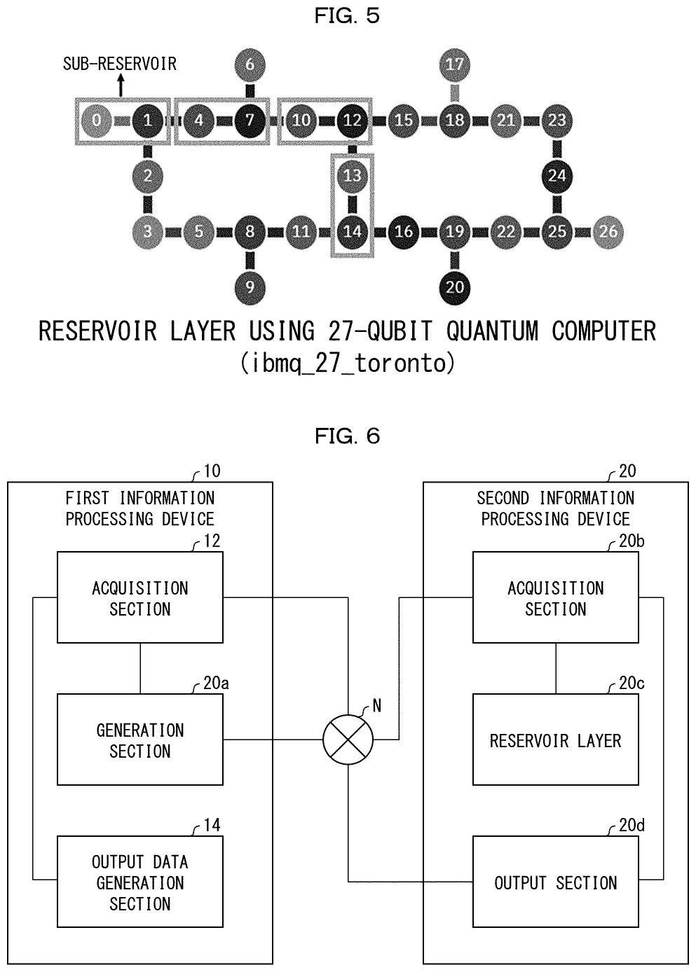

In the training of the reservoir, first, the data of the two fingers was embedded in a 2-qubit sub-reservoir in a 27-qubit quantum computer (ibmq_toronto) manufactured by IBM, as illustrated in FIG. 5, a quantum circuit identical with that in the NARMA task was executed, and measurement was carried out.

Using the output results obtained by the measurement, weights of outputs were adjusted so that the three kinds of objects can be distinguished, and a prediction model was prepared. Table 2 shows results of 10-fold cross validation for the three kinds of objects.

TABLE 2

| | Reservoir | Linear |
|---|---|---|
| | classification | classification |
| | learning | learning |
| Training data | 0.87 | 0.67 |
| accuracy | | |
| Prediction data | 0.83 | 0.67 |
| accuracy | | |

As indicated in Table 2, in the distinction of the three kinds of objects, learning accuracy and prediction accuracy are 0.87 and 0.83, respectively. Therefore, it has been indicated that the reservoir layer in accordance with the present embodiment can accurately learn time series data of the sensor, distinguish between the objects, and accurately control the manipulator through the controller.

In the above embodiment, the robot control system may be a system in which the determination device 10, the controller 30, and the robot 40 are integrated. Alternatively, the robot control system may be configured to use the quantum computer 20 through a cloud.

In other words, the determination device 10 in accordance with the present embodiment may be configured in a distributed manner by: a determination device (referred to as determination device 10a) including an acquisition section 12 and a determination section 14; and a quantum computer 20 that is communicably connected to the determination device 10a. In this configuration, the determination device 10a and the quantum computer 20 communicate with each other via communication sections that are respectively provided in the determination device 10a and the quantum computer 20, and the acquisition section 12 acquires various kinds of data from the quantum computer 20.

In the foregoing configuration in which the quantum computer 20 is used through the cloud, some of components included in the quantum computer 20 may be disposed in the determination device 10a. For example, at least one of the input layer and the output layer may be provided in the determination device 10a rather than in the quantum computer 20. For example, in a configuration in which the determination device 10a includes the output layer, training of the output layer can be carried out without transmitting a connection weight of the output layer to the quantum computer 20 in the training process of the output layer.

As such, in the foregoing configuration in which the quantum computer 20 is used through the cloud, the robot control system in accordance with the present embodiment may be configured to include the determination device 10a and the quantum computation device including the quantum reservoir.

Here, for example, the determination device 10a includes: a first acquisition section (the foregoing acquisition section 12) that acquires time series signals from a sensor provided in a robot; a generation section (e.g., the foregoing input layer) that generates, from the time series signals, reservoir input data which is to be input to a quantum reservoir (the foregoing reservoir layer) having a plurality of layers of sub-reservoirs; a second acquisition section (the foregoing acquisition section 12) that acquires an output result of the quantum reservoir to which the reservoir input data has been input; and a determination section (the foregoing output layer and determination section 14) that determines an action of the robot with reference to the output result.

For example, the foregoing quantum computation device includes a quantum reservoir (the foregoing reservoir layer) having a plurality of layers of sub-reservoirs, acquires reservoir input data which has been generated from time series signals obtained from a sensor provided in a robot, acquires an output result of the quantum reservoir to which the reservoir input data has been input, and outputs the output result to the determination device 10a.

The determination device 10a that carries out the foregoing training process includes: a first acquisition section (the foregoing acquisition section 12) that acquires training data including time series data and label data; a generation section (the foregoing input layer) that generates, from the time series data, reservoir input data which is to be input to a quantum reservoir (the foregoing reservoir layer) having a plurality of layers of sub-reservoirs; and a second acquisition section (the foregoing acquisition section 12) that acquires an output result of the quantum reservoir to which the reservoir input data has been input, the determination device 10a training, with use of the label data, a determination section (the foregoing output layer and determination section 14) that determines an action of the robot with reference to the output result.

### Additional Remarks 1

In the descriptions above, control of a robot has been described as an example of inference and training processes using a quantum reservoir having a plurality of layers of sub-reservoirs. Note, however, that, as can be read from the above descriptions, the process using the quantum reservoir having a plurality of layers of sub-reservoirs is not limited to control of a robot, and may be used in various kinds of applications. Examples of the applications include medical treatment, mobility, collection and delivery, a sorting operation, and the like.

For example, it is possible to employ a configuration in which the acquisition section 12 acquires, as time series data, medical-related data (e.g., vital data such as brain waves, pulse waves, and a respiration rate of a subject), and the determination section 14 carries out inference regarding a body condition of the subject. The time series data may be a blood sugar level, a drug concentration, a dosage, an oxygen level in the blood, and/or the like of the subject. Here, the determination device 10 may output the inference result by the determination section 14 in the form of advice with respect to the subject in the form of an image, a voice, or the like. In such a configuration, the output layer can be trained using training data including vital data (such as brain waves, pulse waves, a respiration rate, a blood sugar level, a drug concentration, a dosage, and an oxygen level in the blood) of a subject and label data which is associated with the vital data and which is related to a body condition.

In a case of the above-described configuration, the acquisition section 12 and the output section that outputs an inference result by the determination section 14 may be provided in separate devices. For example, it is possible to employ a configuration in which: vital data as time series data is acquired by an acquisition section 12 provided in an inspection device installed in a hospital in a certain country; the time series data is input to a quantum reservoir installed in another country; and an image including advice generated by a determination section 14 based on an output result of the quantum reservoir is displayed on a display terminal outside the hospital.

As another example, it is possible to employ a configuration in which: the acquisition section 12 acquires, as time series data, pieces of sensing data of various sensors provided in a target vehicle; and the determination section 14 carries out driving control of the target vehicle. In such a configuration, the output layer can be trained using training data including pieces of sensing data of various sensors provided in the target vehicle and label data which is associated with the pieces of sensing data and which is related to driving control.

The acquisition section 12 may further acquire, as time series data, data of another vehicles traveling around the target vehicle or data of a camera or the like installed near a road, in addition to the pieces of sensing data of various sensors provided in the target vehicle. As such, the time series data acquired by the acquisition section 12 may include time series data from separate devices or apparatuses. Furthermore, the foregoing generation section may be configured to generate reservoir input data based on those pieces of sensing data or after applying a process of integrating those pieces of sensing data. The determination section 14 may be configured to carry out driving control of the target vehicle based on an output result of the quantum reservoir to which such reservoir input data has been input. In such a configuration, types of sensing data and the number of channels increase. It is preferable that, in accordance with such an increase, the quantum reservoir has the number of qubits corresponding to the types of sensing data and the number of channels. Even in a case where a quantum reservoir having such a large number of qubits, the invention described herein is useful.

Therefore, aspects described herein can also be expressed as follows.

### Aspect A1

An information processing device, including: a first acquisition section that acquires input data; a generation section that generates, from the input data, reservoir input data which is to be input to a quantum reservoir having a plurality of layers of sub-reservoirs; a second acquisition section that acquires an output result (measurement result) from the quantum reservoir to which the reservoir input data has been input; and an output data generation section that generates output data with reference to the output result.

### Aspect B1

An information processing device, including: a first acquisition section that acquires training data including input data and label data; a generation section that generates, from the input data, reservoir input data which is to be input to a quantum reservoir having a plurality of layers of sub-reservoirs; a second acquisition section that acquires an output result (measurement result) of the quantum reservoir to which the reservoir input data has been input; and a training section that trains, with use of the label data, an output data generation section which generates output data with reference to the output result.

### Aspect C1

An information processing device, including: a quantum reservoir having a plurality of layers of sub-reservoirs; an acquisition section that acquires reservoir input data which has been generated from time series data; a second acquisition section that acquires an output result (measurement result) of the quantum reservoir to which the reservoir input data has been input; and an output section that outputs the output result.

### Configuration Example of Information Processing System Through Cloud

The following description will discuss, with reference to FIG. 6, a configuration example of an information processing system that has the foregoing configuration and that uses a quantum computer through a cloud. When applied to robot control, the information processing system is realized as the robot control system described above.

As illustrated in FIG. 6, the information processing system includes a first information processing device 10 and a second information processing device 20. The first information processing device 10 and the second information processing device 20 are configured to be able to communicate with each other via a network N. For example, the first information processing device 10 has a configuration that corresponds to the foregoing determination device 10 (except for the configuration that corresponds to part of or all of the quantum computer 20). For example, the second information processing device has a configuration that corresponds to the foregoing quantum computer 20 or the foregoing quantum computation device.

### First Information Processing Device

As illustrated in FIG. 6, for example, the first information processing device 10 includes an acquisition section 12, a generation section 20a, and an output data generation section 14.

The acquisition section 12 is configured to acquire input data. Here, as described above, the input data may be time series data from a sensor provided in a robot, vital data such as brain waves, pulse waves, and a respiration rate of a subject, pieces of sensing data of various sensors provided in a target vehicle, or the like.

The generation section 20a generates, from the input data acquired by the acquisition section 12, reservoir input data which is to be input to a quantum reservoir (reservoir layer 20c in FIG. 6) having a plurality of layers of sub-reservoirs. The generation section 20a can also be regarded as a part of the foregoing input layer. Here, for example, as described above, the generation section 20a divides the input data into a plurality of time slices, and generates the reservoir input data with use of a representative value of the input data in each of the plurality of time slices. Moreover, for example, as described above, the reservoir input data includes information that designates quantum computation with respect to qubits constituting the quantum reservoir.

The acquisition section 12 functions also as a second acquisition section that acquires an output result of the quantum reservoir to which the reservoir input data has been input.

The output data generation section 14 generates output data with reference to the output result of the quantum reservoir. In a case where the acquisition section 12 is configured to acquire, as the input data, time series data from a sensor provided in a robot as described above, the output data generation section 14 generates, as described above, a control signal that corresponds to the output result of the quantum reservoir and that is used to control an action of the robot.

In a case where the acquisition section 12 is configured to acquire, as the input data, vital data such as brain waves, pulse waves, and a respiration rate of a subject as described above, the output data generation section 14 generates output data in the form of advice with respect to the subject in the form of an image, a voice, or the like as described above.

In a case where the acquisition section 12 is configured to acquire, as the input data, pieces of sensing data of various sensors provided in a target vehicle as described above, the output data generation section 14 generates, as described above, control data for carrying out driving control of the target vehicle.

It is possible to employ, as described above, a configuration in which: the acquisition section 12 further acquires label data together with the input data; and the acquisition section 12 functions as a training section that trains the output data generation section with reference to the label data.

### Second Information Processing Device

As illustrated in FIG. 6, for example, the second information processing device 20 includes an acquisition section 20b, a reservoir layer 20c, and an output section 20d.

The acquisition section 20b acquires reservoir input data which has been generated by the generation section 20a included in the first information processing device 10. The acquisition section 20b can also be regarded as a part of the foregoing input layer. The reservoir input data acquired by the acquisition section 20b is input to the reservoir layer 20c.

The reservoir layer 20c is a quantum reservoir having a plurality of layers of sub-reservoirs. Since the quantum reservoir has been described above, the description thereof is omitted here.

The acquisition section 20b functions also as a second acquisition section that acquires an output result of the quantum reservoir to which the reservoir input data has been input.

The output section 20d outputs the output result. For example, the output result is acquired by the acquisition section 12 of the first information processing device 20.

### Example of Information Processing Method in Information Processing System

As can be seen from the above descriptions, information processing in accordance with the present embodiment includes, for example, the following information processing method.

### Information Processing Method 1

An information processing method, including: a first acquisition step of acquiring, by the acquisition section 12, input data; a generation step of generating, by the generation section 20a from the input data, reservoir input data which is to be input to a quantum reservoir having a plurality of layers of sub-reservoirs; a second acquisition step of acquiring, by the acquisition section 12, an output result of the quantum reservoir to which the reservoir input data has been input; and an output data generation step of generating, by the output data generation section 14, output data with reference to the output result.

### Information Processing Method 2

An information processing method, including: a first acquisition step of acquiring, by the acquisition section 12, training data including input data and label data; a generation step of generating, by the generation section 20a from the input data, reservoir input data which is to be input to a quantum reservoir having a plurality of layers of sub-reservoirs; a second acquisition step of acquiring, by the acquisition section 12, an output result of the quantum reservoir to which the reservoir input data has been input; and a training step of training, by the acquisition section 12 (training section) with use of the label data, an output data generation section which generates output data with reference to the output result.

### Information Processing Method 3

An information processing method, including: a first acquisition step of acquiring, by the acquisition section 20b, reservoir input data which has been generated from time series data; a second acquisition step of acquiring, by the acquisition section 20b, an output result of a quantum reservoir (reservoir layer 20c) to which the reservoir input data has been input, the quantum reservoir having a plurality of layers of sub-reservoirs; and an output step of outputting, by the output section 20d, the output result.

### Additional Remarks 2

As partially described above, the sections included in the first information processing device 10 in the foregoing example may be disposed in a plurality of information processing devices in a distributed manner. For example, it is possible to employ a configuration in which: the first information processing device 10 is constituted by an information processing device 10-1 and an information processing device 10-2; the information processing device includes an acquisition section 12 as the first acquisition section that acquires input data and the foregoing generation section 20a; and the information processing device 10-2 includes an acquisition section 12 as the second acquisition section that acquires an output result of the quantum reservoir and the foregoing output data generation section 14. Note, however, that the arrangement in the distributed manner is not limited to the above example.

Similarly, the sections included in the second information processing device 20 in the foregoing example may be disposed in a plurality of information processing devices in a distributed manner. For example, it is possible to employ a configuration in which: the second information processing device 20 is constituted by an information processing device 20-1 and an information processing device 20-2; the information processing device 20-1 includes an acquisition section 20b as the first acquisition section that acquires reservoir input data and the foregoing reservoir layer 20c; and the information processing device 20-2 includes an acquisition section 20 as the second acquisition section that acquires an output result of the reservoir layer and the foregoing output section 20d. Note, however, that the arrangement in the distributed manner is not limited to the above example.

The foregoing information processing system may have a configuration in which pieces of data are supplied from a plurality of first information processing devices 10 to one or more second information processing devices, and the plurality of first information processing devices 10 acquire data from the one or more second information processing devices. Here, each of the plurality of first information processing devices 10 may be configured in a distributed manner, as described above. For example, it is possible to employ a configuration in which, for carrying out a process, pieces of data from a plurality of foregoing information processing devices 10-1 or data obtained by integrating those pieces of data is supplied to a second information processing device 20, and at least one of a plurality of foregoing information processing devices 10-2 acquires data from the second information processing device 20.

### Additional Remarks 3

### Software Implementation Example

The functions of the determination devices 10 and 10a, the quantum computer 20, a quantum computation device, and the information processing device (hereinafter, referred to as “device”) can be realized by a program for causing a computer to function as the device, the program causing the computer to function as the control blocks of the device.

In this case, the device includes a computer that has at least one control device (e.g., a processor) and at least one storage device (e.g., a memory) as hardware for executing the program. By executing the program with the control device and the storage device, the functions described in the above embodiments are realized.

The program can be stored in one or more non-transitory computer-readable storage mediums. The storage medium can be provided in the device, or the storage medium does not need to be provided in the device. In the latter case, the program can be supplied to the device via an arbitrary wired or wireless transmission medium.

One or some or all of the functions of the control blocks can be realized by a logic circuit. For example, an integrated circuit in which a logic circuit that functions as the control blocks is formed is also encompassed in the scope of the present invention.

### Additional Remarks 4

The invention described herein includes the following features.

### Aspect D1

A robot control system, including: an acquisition section that acquires time series signals from a sensor provided in a robot; a determination section that determines, with use of a reservoir layer, an action of the robot based on an output signal from the sensor, the reservoir layer having a plurality of layers of sub-reservoirs in each of which a plurality of qubits are grouped, and the reservoir layer having been processed and trained while using the signals as input and setting an action of the robot as output; and a controller that controls an action of the robot based on the determination result.

### Aspect D2

The robot control system according to aspect D1, in which the reservoir layer has two or more layers of sub-reservoirs.

### Aspect D3

The robot control system according to aspect D1 or D2, in which: the reservoir layer is a nonlinear physical system that utilizes dynamics of a qubit.

### Aspect D4

The robot control system according to any one of aspects D1 through D3 in which: the sensor is a pressure sensor, a vibration sensor, or a camera sensor.

### Aspect D5

A robot system including: the robot control system according to any one of aspects D1 through D4; and a robot.

### Aspect D6

A robot control method, including: a step of acquiring time series signals from a sensor provided in a robot; a step of determining, with use of a reservoir layer, an action of the robot based on an output signal from the sensor, the reservoir layer having a plurality of layers of sub-reservoirs in each of which a plurality of qubits are grouped, and the reservoir layer having been processed and trained while using the signals as input and setting an action of the robot as output; and a step of controlling an action of the robot based on the determination result.

The present invention is not limited to the above embodiment, and the constituent elements can be modified and embodied without departing from the gist in the phase of implementation. Various inventions can be made by appropriately combining the plurality of constituent elements disclosed in the above embodiment. For example, some constituent elements may be deleted from all the constituent elements indicated in the embodiment. Furthermore, the constituent elements across different embodiments may be appropriately combined.

### REFERENCE SIGNS LIST

10, 10a: Determination device
20: Quantum computer
30: Controller
40: Robot

1. An information processing device, comprising at least one processor carrying out:
a first acquisition process to acquire input data;
a generation process to generate, from the input data, reservoir input data which is to be input to a quantum reservoir having a plurality of layers of sub-reservoirs;
a second acquisition process to acquire an output result of the quantum reservoir to which the reservoir input data has been input; and
an output data generation process to generate, by an output data generator, output data with reference to the output result.

2. The information processing device as set forth in claim 1, wherein:
the generation process divides the input data into a plurality of time slices, and generates the reservoir input data with use of a representative value of the input data in each of the plurality of time slices.

3. The information processing device as set forth in claim 1, wherein:
the reservoir input data includes information that designates quantum computation with respect to qubits constituting the quantum reservoir.

4. The information processing device as set forth in claim 1, wherein:
the first acquisition process further acquires label data together with the input data; and
the at least one processor further carries out a training process to train the output data generator with reference to the label data.

5. The information processing device as set forth in claim 1, wherein:
the quantum reservoir has two or more layers of sub-reservoirs.

6. The information processing device as set forth in claim 1, wherein:
the quantum reservoir is a nonlinear physical system that utilizes dynamics of a qubit.

7. The information processing device as set forth in claim 1, wherein:
the input data includes time series signals from a sensor that is provided in a robot;
the quantum reservoir is a trained quantum reservoir which has been trained using the time series signals as input and which outputs an action of the robot; and
the output data generation process generates a control signal which corresponds to an output result of the quantum reservoir and which is used to control an action of the robot.

8. The information processing device as set forth in claim 7, wherein:
the sensor is a pressure sensor, a vibration sensor, or a camera sensor.

9. A robot system, comprising:
an information processing device recited in claim 7; and
a robot.

10. An information processing device, comprising at least one processor carrying out:
a first acquisition process to acquire training data including input data and label data;
a generation process to generate, from the input data, reservoir input data which is to be input to a quantum reservoir having a plurality of layers of sub-reservoirs;
a second acquisition process to acquire an output result of the quantum reservoir to which the reservoir input data has been input; and
a training process to train, with use of the label data, an output data generator which generates output data with reference to the output result.

11. An information processing device, comprising:
a quantum reservoir having a plurality of layers of sub-reservoirs; and
at least one processor carrying out,
a first acquisition process to acquire reservoir input data which has been generated from time series data,
a second acquisition process to acquire an output result of the quantum reservoir to which the reservoir input data has been input, and
an output process to output the output result.

12. An information processing system comprising a first information processing device and a second information processing device,
the first information processing device including at least a first processor carrying out
a first acquisition process to acquire input data,
a generation process to generate, from the input data, reservoir input data which is to be input to a quantum reservoir having a plurality of layers of sub-reservoirs,
a second acquisition process to acquire an output result of the quantum reservoir to which the reservoir input data has been input, and
an output data generation process to generate output data with reference to the output result, and
the second information processing device including
a quantum reservoir having a plurality of layers of sub-reservoirs, and
at least a second processor carrying out
a third acquisition process to acquire reservoir input data which has been generated by the generation process of the first information processing device,
a fourth acquisition process to acquire an output result of the quantum reservoir to which the reservoir input data has been input, and
an output process to output the output result.

13. An information processing method, comprising:
a first acquisition step of acquiring input data;
a generation step of generating, from the input data, reservoir input data which is to be input to a quantum reservoir having a plurality of layers of sub-reservoirs;
a second acquisition step of acquiring an output result of the quantum reservoir to which the reservoir input data has been input; and
an output data generation step of generating output data with reference to the output result.

14. An information processing method, comprising:
a first acquisition step of acquiring training data including input data and label data;
a generation step of generating, from the input data, reservoir input data which is to be input to a quantum reservoir having a plurality of layers of sub-reservoirs;
a second acquisition step of acquiring an output result of the quantum reservoir to which the reservoir input data has been input; and
a training step of training, with use of the label data, an output data generator which generates output data with reference to the output result.

15. An information processing method, comprising:
a first acquisition step of acquiring reservoir input data which has been generated from time series data;
a second acquisition step of acquiring an output result of a quantum reservoir to which the reservoir input data has been input, the quantum reservoir having a plurality of layers of sub-reservoirs; and
an output step of outputting the output result.

16. A non-transitory storage medium storing therein a program for causing a computer to function as an information processing device, the program causing the computer to carry out:
a first acquisition step of acquiring input data;
a generation step of generating, from the input data, reservoir input data which is to be input to a quantum reservoir having a plurality of layers of sub-reservoirs;
a second acquisition step of acquiring an output result of the quantum reservoir to which the reservoir input data has been input; and
an output data generation step of generating output data with reference to the output result.

17. A non-transitory storage medium storing therein a program for causing a computer to function as an information processing device, the program causing the computer to carry out:
a first acquisition step of acquiring training data including input data and label data;
a generation step of generating, from the input data, reservoir input data which is to be input to a quantum reservoir having a plurality of layers of sub-reservoirs;
a second acquisition step of acquiring an output result of the quantum reservoir to which the reservoir input data has been input; and
a training step of training, with use of the label data, an output data generator which generates output data with reference to the output result.
